(19) United States
(12) Patent Application Publication
(10) Pub. No.: US 2025/0268424 A1
(43) Pub. Date: Aug. 28, 2025

(54) Motorized Grinder Device

(71) Applicant: Jason Davis, Ambler, PA (US)

(72) Inventor: Jason Davis, Ambler, PA (US)

(21) Appl. No.: 18/588,654

(22) Filed: Feb. 27, 2024

(51) Int. Cl. A47J 42/26; A47J 42/30

(52) U.S. Cl. CPC A47J 42/26; A47J 42/30

(57) ABSTRACT

A motorized grinder device for grinding herbs and other plant matter into particulates with a motorized blade and sorting the particulates by size includes a housing. A power source is positioned inside the housing. A motor is electrically coupled to the power source. The motor rotates a plurality of blades coupled to the housing for grinding an herb. A chamber is removably couplable to the housing. The plurality of blades is positioned within the chamber when the chamber is coupled to the housing so that the plurality of blades can grind the herb within the chamber. The chamber includes a mesh screen that supports the herb within the chamber. The mesh screen is foraminous to release a granulated residue of the herb from the chamber when the herb is ground. A tray is removably couplable to the chamber to catch the granulated residue of the herb.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to herb grinders and more particularly pertains to a new herb grinder for grinding herbs and other plant matter into particulates with a motorized blade and sorting the particulates by size.

### (2) Description of Related Art Including Information Disclosed Under 37 CFR 1.97 and 1.98

The prior art relates to herb grinders. Most herb grinders are manually operated. When a user has physical mobility concerns, such as arthritis, using a manual herb grinder can be difficult and painful. Thus, there is a need for a motorized herb grinder. The prior art does disclose some electric, motorized herb grinders. However, the prior art fails to disclose an electric herb grinder that can sort the ground particulates of the herbs by size. For example, a user might desire roughly ground herbs for one purpose, and more finely ground particulate residue for another purpose. The prior art fails to disclose a single motorized device that can remove the finely ground particulate residue from the roughly ground herbs.

### BRIEF SUMMARY OF THE INVENTION

An embodiment of the disclosure meets the needs presented above by generally comprising a housing having an interior space. A power source is positioned in the interior space. A motor is positioned in the interior space. The motor is electrically coupled to the power source. A plurality of blades is coupled to the housing. The plurality of blades is coupled to the motor wherein the motor rotates the plurality of blades when the motor is actuated. The plurality of blades is sharpened wherein the plurality of blades is configured to grind an herb when the herb contacts the plurality of blades. A chamber is removably couplable to the housing. The chamber is configured to hold the herb. The plurality of blades is positioned within the chamber when the chamber is coupled to the housing wherein the plurality of blades is configured to grind the herb within the chamber when the motor rotates the plurality of blades. The chamber includes a mesh screen that is positioned within the chamber wherein the mesh screen is configured to support the herb while the herb is held in the chamber. The mesh screen is foraminous wherein the mesh screen is configured to retain the herb in the chamber when the herb is ground and wherein the mesh screen is configured to release a granulated residue of the herb from the chamber when the herb is ground. A tray is removably couplable to the chamber wherein the tray is configured to catch the granulated residue of the herb when the tray is coupled to the chamber.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top exploded view of a motorized grinder device according to an embodiment of the disclosure.

FIG. 2 is a bottom exploded view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is a block diagram view of an embodiment of the disclosure.

FIG. 8 is a block diagram view of an embodiment of the disclosure.

### DETAILED DESCRIPTION OF THE INVENTION

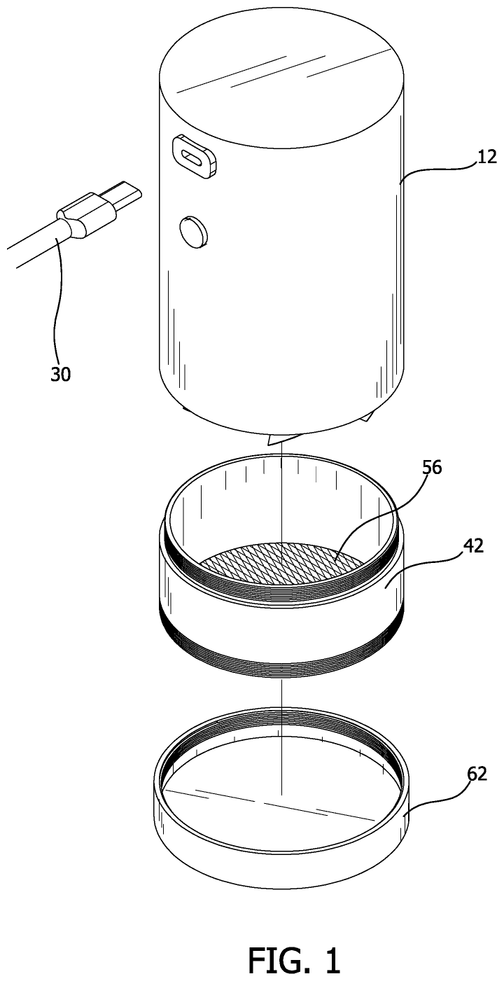

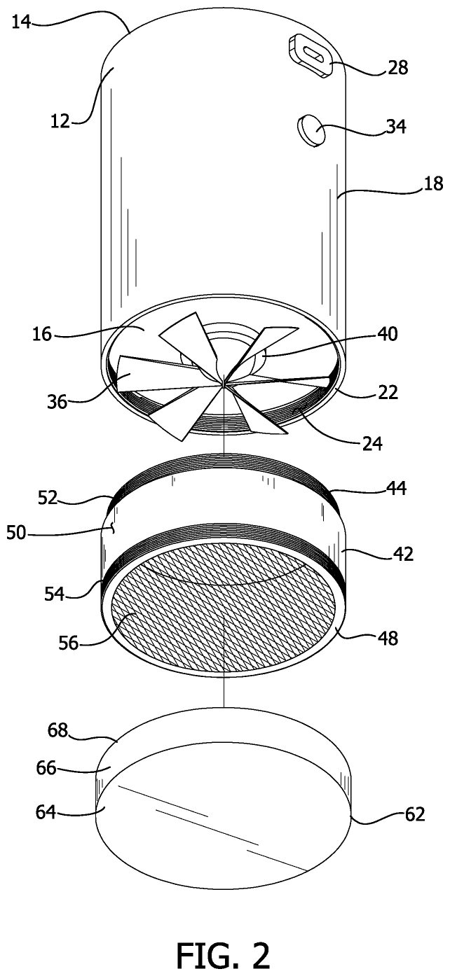

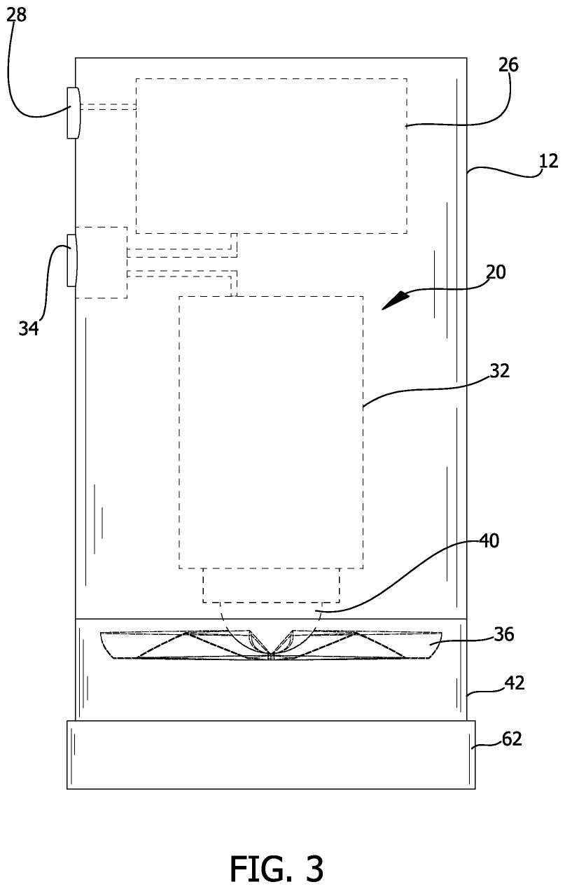

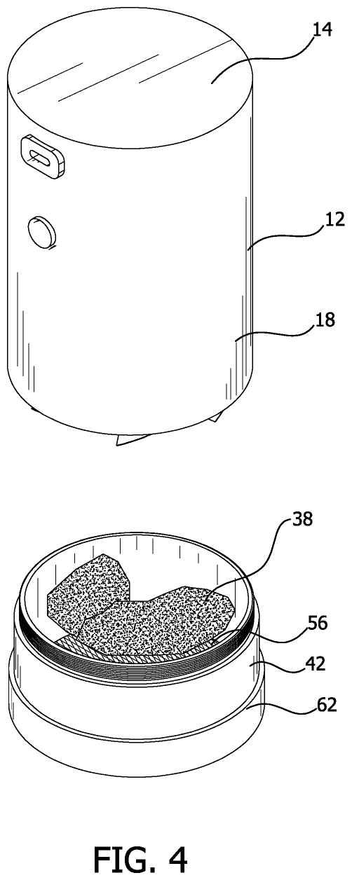

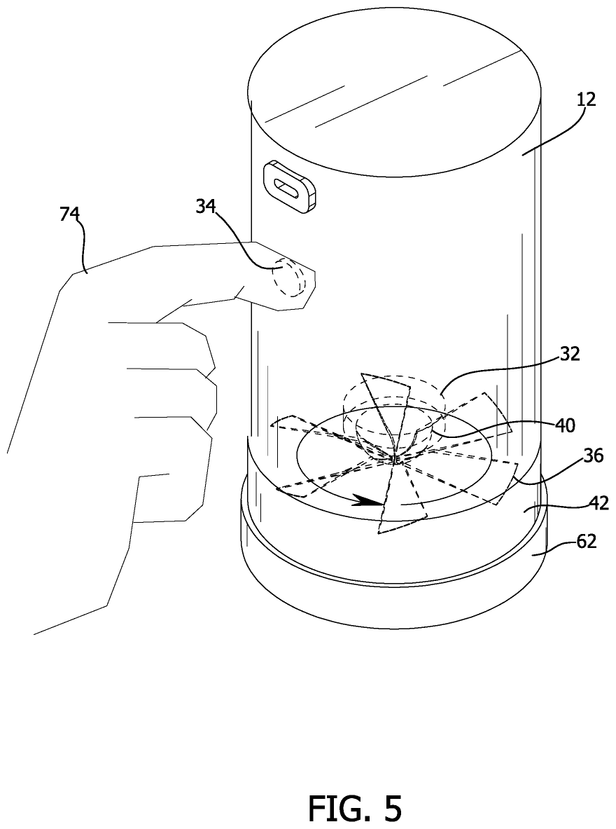

With reference now to the drawings, and in particular to FIGS. 1 through 8 thereof, a new herb grinder embodying the principles and concepts of an embodiment of the disclosure and generally designated by the reference numeral 10 will be described.

As best illustrated in FIGS. 1 through 8, the motorized grinder device 10 generally comprises a housing 12 with an interior space 20. For example, the housing 12 may have a top end 14, a bottom end 16, and an outer wall 18 that is coupled to and extends between the top end 14 and the bottom end 16 to define an interior space 20. The housing 12 may be cylindrical.

The housing 12 may further include a lip 22 that is coupled to and extends downwardly from the bottom end 16. The lip 22 may have a threaded inner surface 24.

A power source 26 is positioned in the interior space 20. The power source 26 may include a battery. The battery may be rechargeable.

A charging port 28 may be electrically coupled to the power source 26. The charging port 28 is designed to receive a charging cable 30 for recharging the power source 26. The charging port 28 may be inset into the outer wall 18 of the housing 12. The charging port 28 may be exposed within the outer wall 18 of the housing 12. For example, the charging port 28 may be positioned adjacent to the top end 14 of the housing 12. In certain embodiments, the charging port 28 is a micro-universal serial bus charging port 28.

A motor 32 is positioned in the interior space 20. The motor 32 is electrically coupled to the power source 26.

A control panel 34 may be electrically coupled to the motor 32. The control panel 34 actuates the motor 32 when the control panel 34 is manipulated. For example, the control panel 34 may be a button. The control panel 34 may be positioned on the outer wall 18 proximate to the top end 14 of the housing 12 to facilitate a user 74 in manipulating the control panel 34 while the user 74 is holding the housing 12.

A plurality of blades 36 is coupled to the housing 12. The plurality of blades 36 is generally rotatably coupled to the bottom end 16 of the housing 12. The plurality of blades 36 is coupled to the motor 32 wherein the motor 32 rotates the plurality of blades 36 when the motor 32 is actuated. The plurality of blades 36 is sharpened wherein the plurality of blades 36 is designed to grind an herb 38 when the herb 38 contacts the plurality of blades 36.

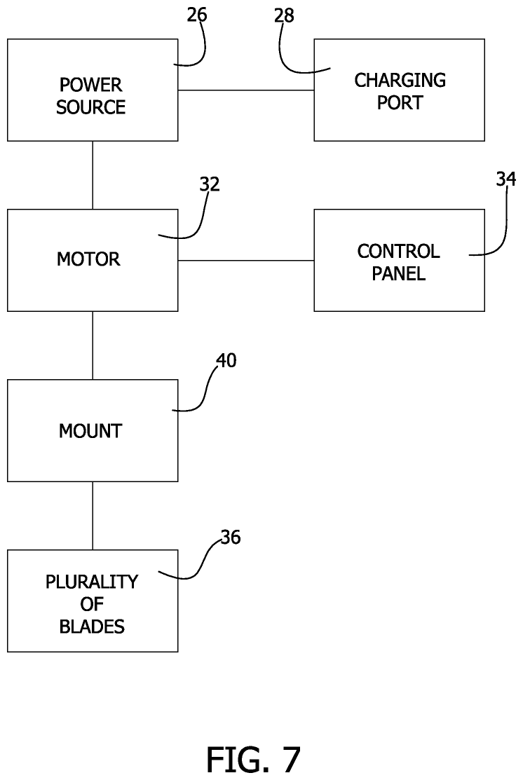

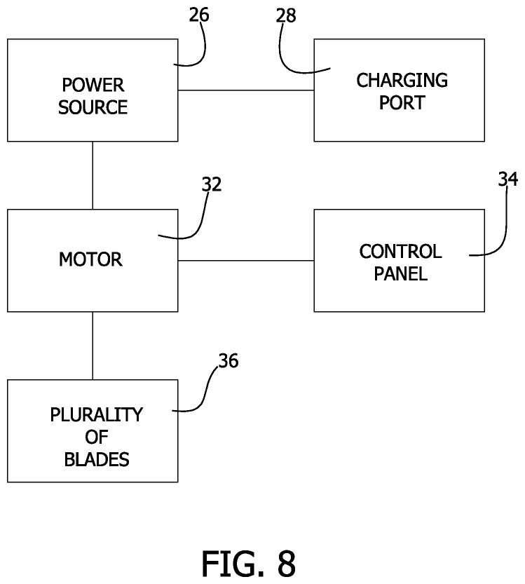

Some embodiments include a mount 40 that rotatably couples the plurality of blades 36 to the bottom end 16 of the housing 12. The mount 40 may be rotatably coupled to the housing 12 wherein the motor 32 rotates the mount 40 to rotate the plurality of blades 36. An example of such embodiments is provided in FIG. 7. Alternatively, the mount 40 may be immovably coupled to the housing and the motor may rotate the plurality of blades directly. An example of such an embodiment is provided in FIG. 8.

The mount 40 generally extends outwardly from the bottom end 16 of the housing 12 wherein the mount 40 is designed to space the plurality of blades 36 from the housing 12. For example, the mount 40 may have a hemispherical shape. The mount 40 may be centrally positioned on the bottom end 16 of the housing 12 wherein the mount 40 is designed to center the plurality of blades 36 relative to the bottom end 16 of the housing 12.

A chamber 42 is removably couplable to the housing 12. The chamber 42 is designed to hold the herb 38. The mount 40 and the plurality of blades 36 may be positioned within the chamber 42 when the chamber 42 is coupled to the housing 12 wherein the plurality of blades 36 is designed to grind the herb 38 within the chamber 42 when the motor 32 rotates one or both of the mount 40 and the plurality of blades 36.

The chamber 42 may further include an upper edge 44 that is positioned adjacent to the housing 12 when the chamber 42 is coupled to the housing 12. The upper edge 44 generally defines an opening 46 into the chamber 42. The opening 46 is generally configured to facilitate the user 74 in placing the herb 38 within the chamber 42. The upper edge 44 may be coupled to the lip 22 of the housing 12 when the chamber 42 is coupled to the housing 12.

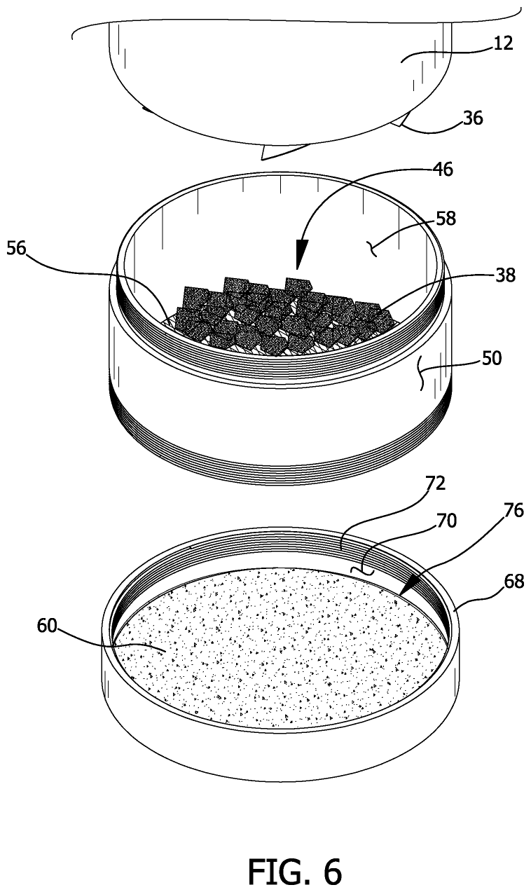

A lower edge 48 of the chamber is spaced from the upper edge 44. An exterior surface 50 extends between the upper edge 44 and the lower edge 48. The exterior surface 50 may further include an upper chamber threading 52 extending downwardly from the upper edge 44 toward the lower edge 48. A lower chamber threading 54 may extend upwardly along the exterior surface 50 from the lower edge 48 toward the upper edge 44. The lower chamber threading may be spaced from the upper chamber threading 52, as shown in FIGS. 1 and 6.

A mesh screen 56 is coupled to an interior surface 58 of the chamber 42. The mesh screen 56 is generally positioned within the chamber 42 adjacent to the lower edge 48 wherein the mesh screen 56 is designed to support the herb 38 while the herb 38 is held in the chamber 42. The mesh screen 56 is foraminous wherein the mesh screen 56 is designed to retain the herb 38 in the chamber 42 when the herb 38 is ground and wherein the mesh screen 56 is designed to release a granulated residue 60 of the herb 38 from the chamber 42 when the herb 38 is ground.

The upper chamber threading 52 is generally complementary to the threaded inner surface 24 of the lip 22 of the housing 12 wherein the chamber 42 is threadably couplable to the housing 12.

A tray 62 is removably couplable to the chamber 42. The tray 62 may have a base wall 64 and a peripheral wall 66 that is coupled to and extends upwardly from the base wall 64 wherein the tray 62 is designed to catch the granulated residue 60 of the herb 38 when the tray 62 is coupled to the chamber 42.

The peripheral wall 66 may have a free edge 68 that is spaced from the base wall 64. The free edge 68 may define an orifice 76 that is designed to facilitate access to the granulated residue 60 when the tray 62 is removed from the chamber 42. An interior side 70 of the peripheral wall 66 may have a tray threading 72 extending downwardly from the free edge 68 toward the base wall 64. The tray threading 72 is complementary to the lower chamber threading 54 on the exterior surface 50 of the chamber 42 wherein the tray 62 is threadably couplable to the chamber 42.

In use, the user 74 can place the herb 38 onto the mesh screen 56 within the chamber 42. The user 74 can threadably couple the housing 12 and the tray 62 to opposing lateral ends of the chamber 42. More specifically, the lip 22 of the housing 12 can be coupled to the upper chamber threading 52 extending from the upper edge 44 of the chamber 42, and the peripheral wall 66 of the tray 62 can be coupled to the lower chamber threading 54 extending from the lower edge 48 of the chamber 42. The tray 62 is thus positioned directly beneath the mesh screen 56 to catch the granulated residue 60 of the herb 38 as the herb 38 is being ground by the plurality of blades 36. The user 74 can use the control panel 34 to actuate the motor 32 to rotate the plurality of blades 36 and grind the herb 38. The ground herb 38 can then be removed from the motorized grinder device 10 by detaching the chamber 42 from the housing 12. To access the granulated residue 60, the user 74 can detach the tray 62 from the chamber 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electric herb grinding assembly comprising:
a housing having an interior space;
a power source being positioned in the interior space;
a motor being electrically coupled to the power source;
a plurality of blades being coupled to the housing, the plurality of blades being coupled to the motor wherein the motor rotates the plurality of blades when the motor is actuated, the plurality of blades being sharpened wherein the plurality of blades is configured to grind an herb when the herb contacts the plurality of blades;
a chamber being removably couplable to the housing, the chamber being configured to hold the herb, the plurality of blades being positioned within the chamber when the chamber is coupled to the housing wherein the plurality of blades is configured to grind the herb within the chamber when the motor rotates the plurality of blades, the chamber further comprising:
a mesh screen being positioned within the chamber wherein the mesh screen is configured to support the herb while the herb is held in the chamber, the mesh screen being foraminous wherein the mesh screen is configured to retain the herb in the chamber when the herb is ground and wherein the mesh screen is configured to release a granulated residue of the herb from the chamber when the herb is ground; and
a tray being removably couplable to the chamber wherein the tray is configured to catch the granulated residue of the herb when the tray is coupled to the chamber.

2. The electric herb grinding assembly of claim 1, further comprising:
a lip being coupled to and extending downwardly from the bottom end of the housing, the lip having a threaded inner surface; and
an upper chamber threading extending downwardly from an exterior surface of an upper edge of the chamber, the upper chamber threading being complementary to the threaded inner surface of the lip of the housing wherein the chamber is threadably couplable to the housing.

3. The electric herb grinding assembly of claim 1, further comprising:
a lower edge of the chamber being positioned adjacent to the mesh screen, the lower edge having a lower chamber threading extending upwardly from an exterior surface of the lower edge;
a tray threading extending downwardly from a free edge of the tray, the tray threading being complementary to the lower chamber threading on the exterior surface of the chamber wherein the tray is threadably couplable to the chamber.

4. The electric herb grinding assembly of claim 1, further comprising a charging port being electrically coupled to the power source, the charging port being configured to receive a charging cable for recharging the power source.

5. The electric herb grinding assembly of claim 1, the charging port being inset into an outer wall of the housing, the charging port being exposed within the outer wall of the housing.

6. The electric herb grinding assembly of claim 1, further comprising a mount rotatably coupling the plurality of blades to a bottom end of the housing.

7. The electric herb grinding assembly of claim 6, wherein the mount is rotatably coupled to the housing wherein the motor rotates the mount to rotate the plurality of blades.

8. The electric herb grinding assembly of claim 6, wherein the mount is centrally positioned on the bottom end of the housing wherein the mount is configured to center the plurality of blades relative to the bottom end of the housing.

9. The electric herb grinding assembly of claim 6, wherein the mount extends outwardly from the bottom end of the housing wherein the mount is configured to space the plurality of blades from the housing.

10. The electric herb grinding assembly of claim 1, further comprising a control panel being electrically coupled to the motor, the control panel actuating the motor when the control panel is manipulated.

11. The electric herb grinding assembly of claim 10, wherein the control panel is positioned on the housing.

12. An electric herb grinding assembly comprising:
a housing having a top end, a bottom end, and an outer wall being coupled to and extending between the top end and the bottom end to define an interior space, the housing being cylindrical, the housing further comprising:
a lip being coupled to and extending downwardly from the bottom end, the lip having a threaded inner surface;
a power source being positioned in the interior space, the power source comprising a battery, the battery being rechargeable;
a charging port being electrically coupled to the power source, the charging port being configured to receive a charging cable for recharging the power source, the charging port being inset into the outer wall of the housing, the charging port being exposed within the outer wall of the housing, the charging port being positioned adjacent to the top end of the housing, the charging port being a micro-universal serial bus charging port;
a motor being positioned in the interior space, the motor being electrically coupled to the power source;
a control panel being electrically coupled to the motor, the control panel actuating the motor when the control panel is manipulated, the control panel being positioned on the outer wall proximate to the top end of the housing;
a plurality of blades being coupled to the housing, the plurality of blades being rotatably coupled to the bottom end of the housing, the plurality of blades being coupled to the motor wherein the motor rotates the plurality of blades when the motor is actuated, the plurality of blades being sharpened wherein the plurality of blades is configured to grind an herb when the herb contacts the plurality of blades;
a mount rotatably coupling the plurality of blades to the bottom end of the housing, the mount being rotatably coupled to the housing wherein the motor rotates the mount to rotate the plurality of blades, the mount being centrally positioned on the bottom end of the housing wherein the mount is configured to center the plurality of blades relative to the bottom end of the housing, the mount extending outwardly from the bottom end of the housing wherein the mount is configured to space the plurality of blades from the housing, the mount having a hemispherical shape;
a chamber being removably couplable to the housing, the chamber being configured to hold the herb, the mount and the plurality of blades being positioned within the chamber when the chamber is coupled to the housing wherein the plurality of blades is configured to grind the herb within the chamber when the motor rotates the mount, the chamber further comprising:
an upper edge being positioned adjacent to the housing when the chamber is coupled to the housing, the upper edge defining an opening into the chamber, the upper edge being coupled to the lip of the housing when the chamber is coupled to the housing;
a lower edge being spaced from the upper edge;
an exterior surface extending between the upper edge and the lower edge, the exterior surface further comprising:
an upper chamber threading extending downwardly from the upper edge toward the lower edge;
a lower chamber threading extending upwardly from the lower edge toward the upper edge, the lower chamber threading being spaced from the upper chamber threading;
a mesh screen being coupled to an interior surface of the chamber, the mesh screen being positioned within the chamber adjacent to the lower edge wherein the mesh screen is configured to support the herb while the herb is held in the chamber, the mesh screen being foraminous wherein the mesh screen is configured to retain the herb in the chamber when the herb is ground and wherein the mesh screen is configured to release a granulated residue of the herb from the chamber when the herb is ground;
the upper chamber threading being complementary to the threaded inner surface of the lip of the housing wherein the chamber is threadably couplable to the housing; and
a tray being removably couplable to the chamber, the tray having a base wall and a peripheral wall being coupled to and extending upwardly from the base wall wherein the tray is configured to catch the granulated residue of the herb when the tray is coupled to the chamber, the peripheral wall having a free edge being spaced from the base wall, the free edge defining an orifice wherein the free edge is configured to facilitate access to the granulated residue when the tray is removed from the chamber, an interior side of the peripheral wall having a tray threading extending downwardly from the free edge toward the base wall, the tray threading being complementary to the lower chamber threading on the exterior surface of the chamber wherein the tray is threadably couplable to the chamber.
